(19) United States
(12) Patent Application Publication
(10) Pub. No.: US 2011/0046019 A1
(43) Pub. Date: Feb. 24, 2011

(54) METHOD AND APPARATUS FOR IMMOBILIZING TARGET MATERIAL ON SUBSTRATE

(75) Inventor: Su-hyeon KIM, Seoul (KR)

Correspondence Address: CANTOR COLBURN LLP, 20 Church Street, 22nd Floor, Hartford, CT, 06103, US

(73) Assignee: SAMSUNG ELECTRONICS CO., LTD., Suwon-si (KR)

(21) Appl. No.: 12/702,381

(22) Filed: Feb. 9, 2010

(30) Foreign Application Priority Data
Aug. 18, 2009 (KR) 10-2009-0076388

(51) Int. Cl. C40B 50/18; C40B 60/14

(52) U.S. Cl. 506/32; 506/40

(57) ABSTRACT

A method for immobilizing a target material on a substrate includes applying a voltage across a first solution including the target material in contact with a surface of a film including a pore disposed therein, a second solution in contact with an opposite surface of the film, and a substrate disposed facing the opposite surface of the film, moving the target material from the first solution, through the pore of the film into the second solution, and immobilizing the target material on the substrate.

### CROSS-REFERENCE TO RELATED APPLICATIONS

This application claims priority to Korean Patent Application No. 10-2009-0076388, filed on Aug. 18, 2009, and all the benefits accruing therefrom under 35 U.S.C. §119, the disclosure of which is incorporated herein in its entirety by reference.

### BACKGROUND

1. Field

One or more embodiments of the invention relate to a method and apparatus for immobilizing a target material on a substrate.

2. Description of the Related Art

It is generally known that a method of immobilizing a target material on a solid substrate includes a method of synthesizing the target material directly on a substrate, and a method of immobilizing a prepared target material on a predetermined location of a substrate. In order to immobilize a target material that is previously synthesized, a spotting method, a piezoelectric printing method and a micropipetting method may be used. Generally, by immobilizing biological molecules that are previously synthesized on a substrate, the biological molecules may be freely arranged on the substrate, and thus the method of immobilizing a prepared target material has been widely used.

A method of immobilizing a target material on a substrate including combining a single deoxyribonucleic acid (“DNA”) molecule onto a surface of a well-ordered pattern, so that the single DNA molecule is combined with a single pattern. This method uses a rolling circle amplification method in which another DNA molecule is not combined with a portion of a substrate within several hundreds of nanometers by forming a linear or branched DNA clone so that a single DNA molecule is immobilized on a single pattern. Generally, a single DNA fragment is too small to selectively immobilize only a single DNA molecule. Therefore, this method is used in order to combine a single DNA molecule with a single pattern. However, in this method, a single DNA molecule needs to be amplified in order to form a microarray chip. Thus, the time taken to perform this method is long, and it is difficult to apply this method to another target material, except for DNA.

Therefore, there is a need for an efficient method and apparatus for immobilizing a target material on a substrate.

### SUMMARY

One or more embodiments of the invention include a method and apparatus for immobilizing a target material on a substrate.

Exemplary embodiments will be set forth in part in the description which follows and, in part, will be apparent from the description, or may be learned by practice of the illustrated embodiments.

According to one or more embodiments of the invention, a method of immobilizing a target material on a substrate includes applying a voltage across a first solution including the target material in contact with a surface of a film including a pore disposed therein, a second solution in contact with an opposite surface of the film, and a substrate disposed at the opposite surface of the film, moving the target material through the pore of the film and immobilizing the target material on the substrate.

A diameter of the narrowest cross section of the pore may be, for example, in the range of about 1 nanometer (nm) to about 1000 nanometers (nm).

The film may include a plurality of pores, or may include an array of a plurality of pores.

The target material may be at least one selected from the group consisting an organic material, an inorganic material and any mixtures thereof, and for example, may be selected from the group consisting of nucleic acid or modified nucleic acid (e.g., deoxyribonucleic acid (“DNA”), ribonucleic acid (“RNA”), peptide nucleic acid (“PNA”), or locked nucleic acid (“LNA”)), protein, peptide, polysaccharides, a metal particle and any mixtures thereof, but the embodiments are not limited thereto.

The target material may include a reactant group that couples with the substrate.

The first solution, and/or the second solution in contact with the opposite surface of the film, may be a buffer solution including electrolyte. A polarity of the voltage applied to the first solution may be opposite to a net charge of the target material, and a polarity of the voltage applied to the second solution may be the same as a net charge of the target material.

The substrate is spaced apart from the opposite surface of the film by a distance in the range of about 1 nm to about 100 nm.

The method of immobilizing the target material on the substrate may further include controlling passage of the target material through the pore by applying a voltage across the pore disposed in the surface of the film. When the voltage is applied across the pore disposed in the film, the passage of the target material through the pores may be controlled by controlling a voltage applied to an electrode disposed around the pores. At this time, a control voltage may be applied to the electrode adjacent to and around the pore of the film, the electrode being disposed at every pore where there is a plurality of pores.

According to one or more embodiments of the invention, an apparatus for immobilizing a target material on a substrate includes a first chamber containing a film with a pore disposed therein, the film being a wall of the first chamber, a second chamber containing the film with the pore disposed therein, the film being a wall of the second chamber, a first electrode that is electrically connected to the first chamber, a second electrode that is electrically connected to the second chamber, and a substrate included in the second chamber. The first electrode and the second electrode are arranged so that a voltage is applied across the film to the first chamber and the second chamber.

The film with the pore disposed therein may be a portion of a wall or an entire wall shared by the first chamber and the second chamber. A direction of the wall may be determined according to embodiments of the invention. The wall may be horizontal. The first chamber may include the first solution that is described with regard to the method of immobilizing a target material on a substrate. The second chamber may contain a substrate and a second solution.

The second chamber may be detachable from the apparatus. The second chamber may be coupled with the apparatus by a coupling unit included in the first chamber or the second chamber. The substrate may be contained in the second chamber or may be positioned to face the film with the pore disposed therein as the wall of the second chamber.

The apparatus may further include a first voltage controlling unit which controls a voltage applied across the pore of the film. In addition, the apparatus may further include an electrode adjacent to and around the pore of the film, the electrode being disposed at each of every pore where there is a plurality of pores. The electrode disposed around each pore and may be ring-shaped. When the apparatus may include an electrode for each pore, the apparatus may further include a second voltage controlling unit which controls a voltage applied to the electrode, independently from the first voltage controlling unit.

The apparatus may further include a distance controlling unit which controls a distance between a surface of the substrate on which the target material is to be immobilized, and the film with the pore disposed therein that is contained in the second chamber. The distance controlling unit may be provided in order to position the substrate so as to be adjacent to the film including the pore, and may be a manual controlling device or an automatic controlling device.

Since some elements of the apparatus are described with regard to the immobilizing, a description that is common to the apparatus and method is omitted, in order to avoid complication.

According to one or more embodiments of the invention, an apparatus for immobilizing a target material on a substrate includes a first chamber containing a film with a pore disposed therein as a wall of the first chamber, a second chamber module, a second chamber module coupling unit which couples the second chamber module with the first chamber so as to form a second chamber including the film with the pore disposed therein as a wall shared with the first chamber, a first electrode that is electrically connected to the first chamber, and a second electrode that is electrically connected to the second chamber. The first electrode and the second electrode are arranged so that a voltage is applied across the film to the first chamber and the second chamber.

A basic principle is the same as that of the above-described method and apparatus.

The second chamber module may be a vessel containing a substrate and including an opened portion facing the film with the pore disposed therein as a wall of the second chamber module. Thus, the substrate may be positioned at a location of the second chamber module where the target material moving through the pore from the first chamber is to be immobilized.

The substrate may be contained in the second chamber or is positioned to face the film with the pore disposed therein as the wall of the second chamber. When the substrate may be included in the second chamber module, the substrate may be included in a solution of the second chamber module or is fixed to a substrate fixation unit. The substrate fixation unit may fix the substrate where the target material is to be immobilized on the second chamber module.

Since some elements of the apparatus are described with regard to the immobilizing, and the basic principle of the apparatus is the same as that of the above-described method and apparatus, a description that is common to the apparatus and method is omitted, in order to avoid complication.

### BRIEF DESCRIPTION OF THE DRAWINGS

These and/or other aspects will become apparent and more readily appreciated from the following description of the embodiments, taken in conjunction with the accompanying drawings of which:

FIGS. 1A-1C are schematic diagrams for explaining an exemplary embodiment of a method of immobilizing a target material on a substrate by an apparatus, according to the invention;

FIGS. 2A-2D is a set of schematic diagrams for explaining another exemplary embodiment of a method of immobilizing a target material on a substrate by an apparatus, in which only a single molecule of the target material is immobilized whenever a voltage is once applied, according to the invention;

FIGS. 3A and 3B are schematic diagrams for explaining another exemplary embodiment of a method of immobilizing a target material in the form of an array on a substrate, according to the invention;

FIG. 4 is a schematic diagram for explaining an exemplary embodiment of an apparatus for immobilizing a target material on a substrate, according to the invention;

FIG. 5 is a schematic diagram for explaining another exemplary embodiment of an apparatus for immobilizing a target material on a substrate, according to the invention; and

FIGS. 6A and 6B show exemplary embodiments of a cross-sectional view of a pore, and a magnified bottom plane view of a film of an apparatus, respectively, according to the invention.

### DETAILED DESCRIPTION

Reference will now be made in detail to embodiments, examples of which are illustrated in the accompanying drawings, wherein like reference numerals refer to the like elements throughout. In this regard, the embodiments may have different forms and should not be construed as being limited to the descriptions set forth herein. Accordingly, the embodiments are merely described below, by referring to the figures, to explain aspects of the description.

It will be understood that when an element or layer is referred to as being “on”, “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “below and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

A method of immobilizing a target material on a substrate includes applying a voltage across a first solution containing the target material in contact with a surface of a film including a pore formed therein, a second solution in contact with an opposite surface of the film, and a substrate disposed at the opposite surface of the film, moving the target material through the pore of the film, and immobilizing the target material on the substrate.

The pore of the film has a nanoscale dimension. The terminology “nanoscale” means that a line passing through the center of the narrowest cross section of the pore is in the range of about 1 nanometer (nm) to about 1000 nanometers (nm). When the pore is a circle, the line is a diameter of the circle. A diameter of the narrowest cross section of the pore may be, for example, in the range of about 1 nm to about 1000 nm. That is, an area of the narrowest cross section may be in the range of about 1 square nanometer (nm²) to about 8×10⁵ square nanometer (nm²).

The film may include a plurality of pores, or may include an array of a plurality of pores. The number of pores may be determined by one of ordinary skill in the art according to the size, kind and use of the substrate. The number of pores may be in the range of about 1 to about 10⁹, or alternatively may be in the range of about 1 to about 10⁶. In this case, the number of pores may be contained per 1 square centimeter (cm²) of the film. In addition, the terminology “array” refers to an arrangement of the pores formed so that target materials are immobilized to be spaced apart from each other on the substrate by a predetermined distance. The arrangement may include a single diagonal direction or both diagonal directions, or a single cross direction or both cross directions.

In order to immobilize the target material, a first solution containing the target material is provided. The terminology “target material” refers to a subject material to be immobilized on the substrate. The target material may include a material having an electric charge or a material having an induced electric charge. The target material may be at least one selected from the group consisting an organic material, an inorganic material and any mixtures thereof, and for example, may be selected from the group consisting of nucleic acid or modified nucleic acid (e.g., deoxyribonucleic acid (DNA), ribonucleic acid (RNA), peptide nucleic acid (PNA), or locked nucleic acid (LNA)), protein, peptide, polysaccharides, a metal particle and any mixtures thereof, but the embodiments are not limited thereto. In addition, in order to move the target material through the pore, a medium material is provided. The medium material may be a buffer solution that is generally known in the art. Thus, in order to immobilize the target material on the substrate by moving the target material through the pore, the first solution in which the target material is dissolved in the medium material (for example, Tris-HCl or a phosphate buffer solution) may be used.

The target material may include a reactant group that couples with the substrate. The target material may be at least one selected from the group consisting of aldehyde, carboxyl, ester, active ester, amino and any mixtures thereof, but the embodiments are not limited thereto. In addition, instead of coupling the reactant group with the target material, the reactant group may be coated on the substrate, and then the target material without the reactant group may be immobilized on the substrate. Alternatively, reactant groups may be included in both the target material and the substrate.

In order to immobilize the target material on the substrate, a voltage may be applied to the first solution and the second solution, where the second solution in contact with the opposite surface of the film may be a buffer solution including electrolyte. The first solution may also be an electrolyte solution. A polarity of the voltage applied to the first solution may be opposite to a net charge of the target material, and a polarity of the voltage applied to the second solution may be the same as a net charge of the target material. Since DNA is a particle charged with a negative (−) polarity, a polarity of the voltage applied to the first solution is a negative (−) polarity, and a polarity of the voltage applied to the second solution is a positive (+) polarity. Thus, DNA moves from the first solution towards the second solution. Since the first solution and the second solution are separated from each other by the film including the pore disposed therein, the target material may pass only through the pore onto the second solution.

The target material contained in the first solution and moved by applying the voltage may be immobilized on the opposite surface of the substrate wherein the second solution is contained.

The substrate is spaced apart from the opposite surface of the film by a distance in the range of about 1 nm to about 100 nm. By positioning the substrate so as to be spaced apart from the opposite surface of the film by a distance of several nanometers, the target material passing through the pore may be immobilized. In order to immobilize the target material, incubation may be performed under an appropriate condition (e.g., a temperature or pH) according to a reactant group.

The substrate may be at least one selected from the group consisting of a metal (e.g., quartz, silicon, germanium, or gallium arsenide), a metal oxide, glass, ceramic, a semiconductor, a Si/SiO₂ wafer, a carbon nanotube, polystyrene, polyethylene, polypropylene, polyacrylamide and any mixtures thereof, but the embodiments are not limited thereto. The substrate may have any shape such as a plate or a bead as long as the target material may be immobilized.

The first solution and the second solution may be contained in the first chamber and the second chamber, respectively. The substrate may be contained in the second solution. In addition, the substrate may be an inner wall of the second chamber. In this case, the voltage may be applied to an electrode that is electrically connected to the first chamber and the second chamber or a wall of the second chamber. A direction of the inner wall may be determined according to embodiments of the invention. The first and second chambers may each include a vessel or well containing a solution of the target material or a solution containing electrolyte.

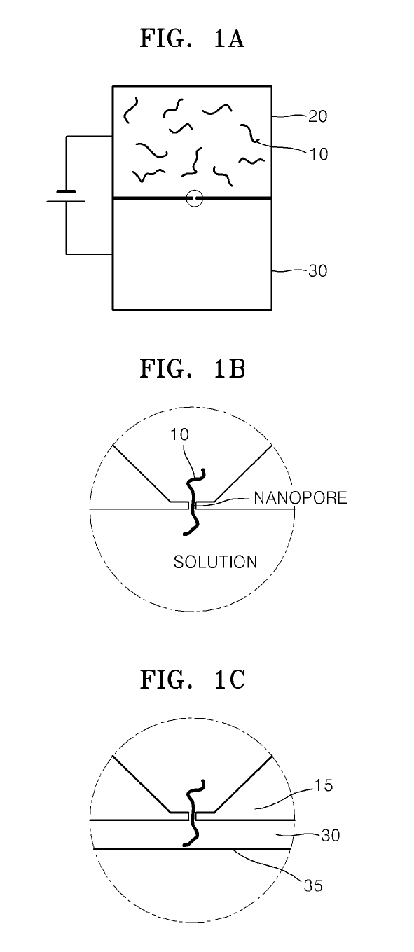

FIGS. 1A-1C are schematic diagrams for explaining an exemplary embodiment of a method of immobilizing a target material on a substrate 35 by an apparatus, according to the invention. In exemplary embodiments, the target material may be nucleic acid such as deoxyribonucleic acid (“DNA”).

As illustrated in FIG. 1A, a solution of target material 10 containing random DNA is put into a first chamber 20. A second chamber 30 is separated from the first chamber 20. A voltage is applied between the first chamber 20 and the second chamber 30 separated from the first chamber 30, by a film 15 including a pore (e.g., a nanopore) or a substrate supplying unit (not shown) included in the second chamber 30. The pore or nanopore, is extended completely through the film 15, and defines a unitary indivisible passage between the first chamber 20 and the second chamber 30. The film 15 may be a unitary indivisible member of an apparatus for immobilizing a target material on a substrate.

In an exemplary embodiment, a polarity of the voltage applied to the first chamber 20 is a negative (−) polarity, that is the same as that of DNA contained in the first chamber 20, and a polarity of the voltage applied to the second chamber 30 or of the substrate supplying unit included in the second chamber 30, is a positive (+) polarity that is opposite to the polarity of the DNA contained in the first chamber 20. Since DNA is a particle charged with a negative (−) polarity, DNA moves from the first chamber 20 towards the second chamber 30 through the pore included in the film 15, as illustrated in FIG. 1B.

As illustrated in FIG. 1C, a substrate 35 is contained in the second chamber 30. If the substrate 35 is adjacent to the pore, the DNA moving from the first chamber 20 and through the pore, comes in contact with the substrate 35. If the DNA has a reactant group that may be coupled to the substrate 35, or conversely, if the substrate 35 has a reactant group that may be coupled to the DNA, the DNA moving through the pore and into the second chamber 30, may be immobilized on the substrate 35. By adjusting a distance between the film 15 including the pore, and the substrate 35, the DNA may be selectively immobilized on a portion of the substrate 35 within several hundreds of nanometers of a predetermined location of the substrate 35.

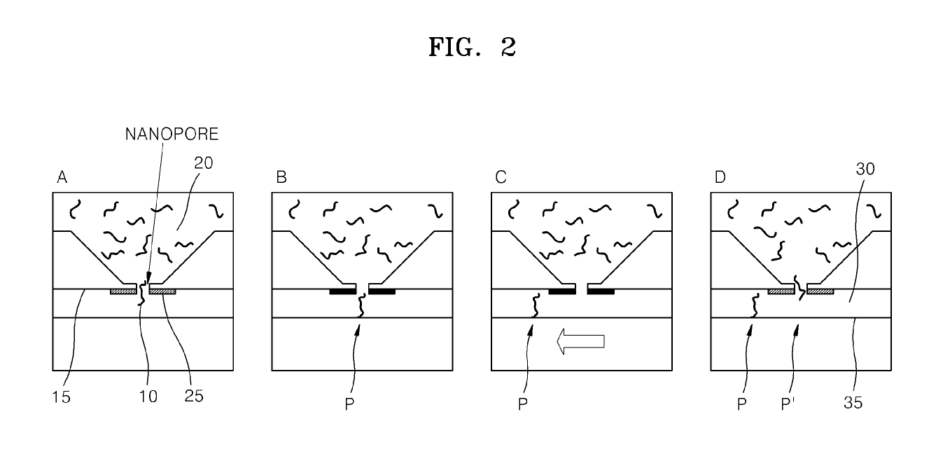

FIGS. 2A-2D is a set of schematic diagrams for explaining an exemplary embodiment of a method of immobilizing a target material on a substrate by an apparatus, in which only a single molecule of the target material is immobilized whenever a voltage is once applied, according to the invention. Referring to FIGS. 1A-1C and 2A, when the target material, for example, a single DNA molecule passes through a pore, the passage of DNA through the pore may be controlled by applying a first voltage only once to a control electrode 25 disposed on the film 15 and facing the pore contained in a surface of the film 15. In one exemplary embodiment, when a single DNA molecule passes from the first chamber 20 through the pore completely, a stop voltage is applied to the control electrode 25 so that another DNA molecule may not pass through the pore. The stop voltage may be different than the first voltage.

As illustrated in FIG. 2B, the single DNA molecule which has passed from the first chamber 20, through the pore and into the second chamber 30, is immobilized on a portion of the substrate 35, at a first predetermined location P on the substrate 35.

In order to detect that only a single molecule of the target material 10 (e.g., a DNA molecule) passes through the pore whenever the first voltage is once applied between the first chamber 20 and the second chamber 30, a method of attaching a fluorescence material to a DNA molecule, and then measuring the amount of the fluorescence material contained in DNA passing through a pore, may be used. Alternatively, a method of measuring current passing through a pore by an external electrode or measuring a tunneling current in a pore, may be used.

In addition, once a single DNA molecule has passed through the pore, another DNA molecule may be prevented from passing through the pore. In an exemplary embodiment, the first voltage between the first chamber 20 and the second chamber 30 may be shut off, movement of the target material 10 due to a voltage difference between the first chamber 20 and the pore may be prevented by applying a stop voltage to an electrode disposed around the pore, and/or another DNA molecule may not pass through the pore by reducing a size of the pore.

As illustrated in FIG. 2C, another single DNA molecule may be immobilized on another location of the substrate 35, which is different from the first predetermined location P. The film 15 containing the pore may be moved relative to the substrate 35 including a first single DNA molecule at the first predetermined location P, such as to align a second predetermined location P′ with the pore. Alternatively, the substrate 35 may be moved relative to the film 15, as indicated by the arrow in FIG. 2C, to align the second predetermined location P′ with the pore. Alternatively, the first chamber 20 containing the film 15, and the second chamber 30 containing the substrate 35, may be moved relative to each other to align the second predetermined location P′ with the pore.

Once the second predetermined location P′ is aligned with the pore, a second voltage is once applied between the first chamber 20 and the second chamber 30. The second voltage may be the same, or different from the first voltage. By repeatedly performing the aligning of a predetermined location for immobilization and the pore, and the application of a voltage between the first and second chambers 20 and 30, a DNA array may be formed by spotting every single DNA molecule of the target material 10, on a substrate 35 in a single pattern.

As described above, where DNA molecules originally have a random arrangement are contained in the first chamber 20, every single DNA molecule may be finally arranged so that the DNA molecules originally having the random arrangement may be spaced apart from each other by a predetermined distance in a single pattern, and a chip on which the spaced DNA molecules are arranged may be used in sequencing of DNA immobilized on the substrate. Since the method of the invention arranges single DNA molecules in the single pattern on the substrate, single DNA molecules do not need to be amplified in order to form a microarray chip, thereby reducing time to form the microarray chip and simplifying the process of forming the microarray chip.

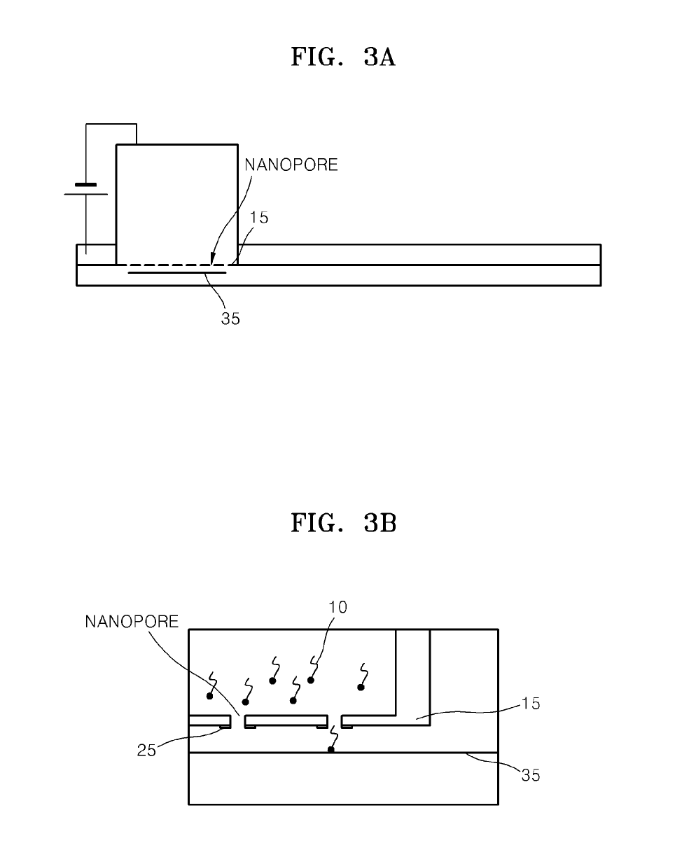

FIGS. 3A and 3B are schematic diagrams for explaining another exemplary embodiment of a method of immobilizing a target material in the form of an array on a substrate, according to the invention. As described above with reference to FIGS. 2A-2D, a plurality of DNA molecules (every single DNA molecule) may be arranged in the form of an array on the substrate by repeatedly performing a method in which a single target material, for example, a single DNA molecule passes through the pore so as to be immobilized on a first predetermined location on the substrate, and then the pore or the film containing the pore is moved to align the pore with a second predetermined location different from the first predetermined location.

As illustrated in FIG. 3B, when a plurality of pores are disposed in the film 15 at predetermined locations arranged in the form of an array, DNA molecules of the target material 10 may be predisposed in the first chamber 20 at locations corresponding to the predetermined locations of the film 15. Where the DNA molecules are predisposed close to the predetermined locations, an individual time to pass a single molecule through a pore of the plurality of pores may be reduced, thereby reducing a total time taken to finally arrange the DNA molecules on the substrate 35 in the second chamber 30.

In order to pass a single molecule of the target material through each pore, the control electrode may be disposed at each pore, such as completely surrounding all edges of the passage between the first and second chambers 20 and 30, defined by the pore. In addition, by controlling a voltage by the control electrode 25, only a single molecule of the target material 10 may be moved through each pore so as to be immobilized on the substrate 35. In an exemplary embodiment, a voltage may be applied to each of the control electrodes 25 at a different (e.g., successive) time, or may be applied to each of the control electrodes 25 at substantially a same time. Where the control electrodes 25 are disposed at each of a plurality of pores, a plurality of target materials may be simultaneously immobilized on the substrate, thereby reducing a total time taken to finally arrange the DNA molecules on the substrate 35 in the second chamber 30.

In an exemplary embodiment, a chip on which DNA molecules are arranged is prepared using the method illustrated in FIGS. 3A and 3B, and then this method is repeatedly performed, thereby reducing the total time taken to immobilize the target material on the substrate. Since the method of the invention illustrated in FIGS. 3A and 3B arranges single DNA molecules in a single pattern on the substrate, single DNA molecules do not need to be amplified in order to form a microarray chip, thereby reducing time to form the microarray chip and simplifying the process of forming the microarray chip.

Referring again to FIG. 3B, in order to immobilize the target material 10 on a surface of the substrate 35, a reactant group that couples the target material 10 to the substrate 35, may be provided on an end of the target material 10 and/or the surface of the substrate 35. In an exemplary embodiment, in order to couple the target material 10 to the substrate 35, a coupling method using affinity between molecules, such as a streptavidin-biotin coupling method, or a covalent bonding method using a chemical reaction, may be used.

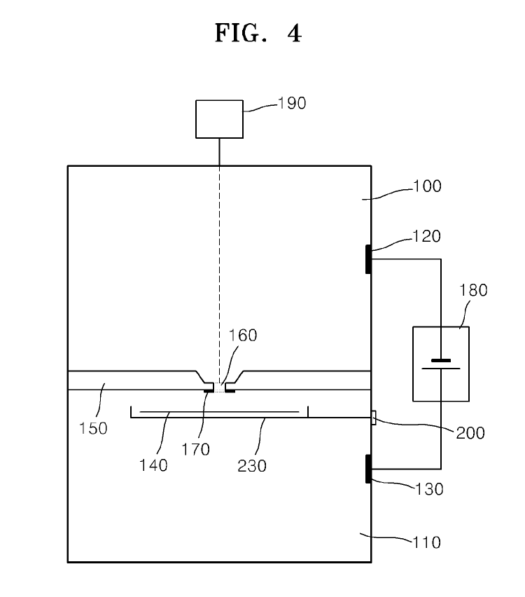

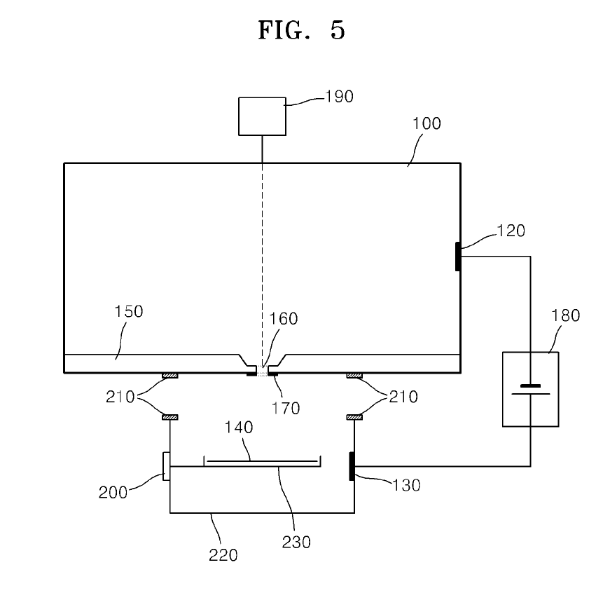

FIGS. 4 and 5 are schematic diagrams for explaining exemplary embodiments of apparatuses for immobilizing a target material on a substrate 140, according to the invention.

With reference to FIGS. 4 and 5, a method and apparatuses for immobilizing the target material on the substrate 140 will be described. The apparatuses include a first chamber 100 containing the target material. The first chamber 100 includes a film 150 including a pore 160 disposed therein. The film 150 constitutes at least a portion of a wall of the first chamber 100. The pore 160 is an enclosed opening completely penetrating the film 150, and the wall of the first chamber 100 (e.g., the film 150) solely defines the enclosed opening pore 160.

In an exemplary embodiment, the target material may be included in a buffer solution as a medium of delivery. The target material may be manually provided into the first chamber 100, or alternatively, may be provided into the first chamber 100 by a separate automatic supplying apparatus (not shown).

The film 150 may include a plurality of a pore, or an array including the pores, and thus a plurality of target materials may be simultaneously immobilized on the substrate 140. The substrate 140 on which the target material is to be immobilized, may be disposed in a second chamber 110 (FIG. 4) or a second chamber module 220 (FIG. 5). Referring to the views in FIGS. 4 and 5, the second chamber 110 and the second chamber module 220 are respectively disposed below the first chamber 100, and the film 150 including the pore 160.

The second chamber module 220 may be a vessel containing the substrate 140 and including an opened portion facing the film 150. Thus, the substrate 140 may be positioned at a location of the second chamber module 220 where the target material moving through the pore 160 from the first chamber 100 is to be immobilized.

The substrate 140 may be disposed in and fixed to a substrate fixation unit 230, so that the target material is appropriately immobilized on the substrate 140. In exemplary embodiments, the substrate 140 is included in the second chamber module 220 or is positioned to face the film 150 with the pore 160 disposed therein. When the substrate 140 is included in the second chamber module 220, and the substrate 140 is included in a solution of the second chamber module 220 or is fixed to the substrate fixation unit 230.

The apparatuses according to the illustrated embodiments may include a distance controlling unit 200, which controls a distance between a surface of the film 150 in which the pore 160 is disposed, and the substrate 140 on which the target material is to be immobilized, in order to position the substrate 140 to be adjacent to the film 150. Referring to FIGS. 4 and 5, the distance between the film 150 and the substrate 140 controlled by the controlling unit 200 is taken in a vertical direction of the drawing, or perpendicular to the surface of the film 150. The distance controlling unit 200 may be installed at the substrate fixation unit 230 (FIGS. 4 and 5), or the film 150.

The apparatus according to the illustrated embodiment of FIG. 5, which includes the second chamber module 220, may further include a second chamber module coupling unit 210, in order to couple the second chamber module 220 to the first chamber 100. The coupled second chamber module 220 and the first chamber 100 collectively forms a second chamber in FIG. 5, which includes the film 150 including the pore 160 disposed therein. Since the second chamber is formed by the coupling of the second chamber module 220 and the first chamber 100, the second chamber is considered detachable from a remainder of the apparatus. The film 150 is a portion of a wall of the formed second chamber that is shared by the first chamber 100.

The target material may be moved towards the second chamber 110 (FIG. 4) or the second chamber module 220 (FIG. 5), by providing the target material contained in the buffer solution to the first chamber 100, providing the buffer solution to the second chamber 110 or the second chamber module 220, respectively, and then applying a voltage from a first voltage controlling unit 180 to a first electrode 120 and a second electrode 130. The first electrode 120 and the second electrode 130 are disposed opposite to each other with respect to the film 150, in the first chamber 100 and the second chamber 110 in FIG. 4. The first electrode 120 and the second electrode 130 are disposed opposite to each other with respect to the film 150, in the first chamber 100 and the second chamber module 220 in FIG. 5. The voltage applied to the first electrode 120 and the second electrode 130 has opposite polarities across the film 150. That is, a polarity of the voltage applied to the first electrode 120 of the first chamber 100 is the same as a net charge of the target material.

Referring to FIGS. 4 and 5, the first chamber 100 and the second chamber 110 are separated from each other by the film 150, and thus the target material may pass through only the pore 160 towards the substrate 140 contained in the second chamber 110 or the second chamber module 220, respectively. An electrode 170 may be disposed around the pore 160, such as surrounding all edges of the pore's opening, or including separate portions disposed on opposing sides of the pore's opening.

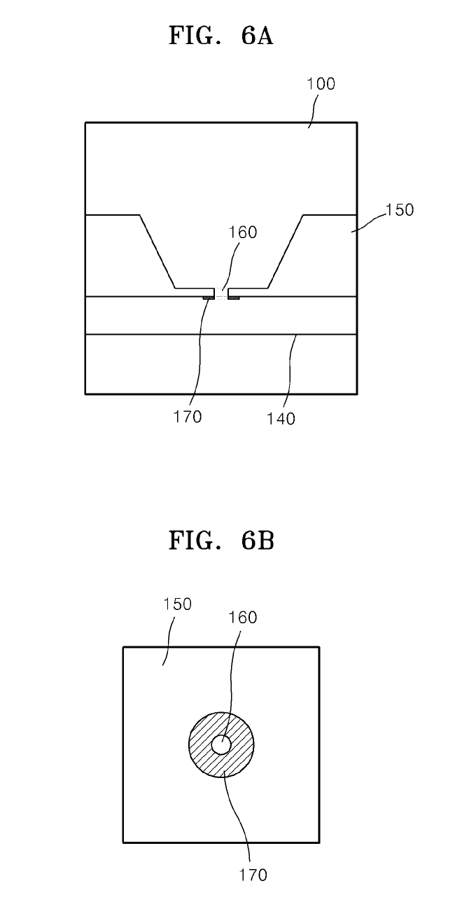

As illustrated in FIGS. 6A and 6B, the electrode 170 may be directly adjacent to the pore 160, such as aligning with edges of the pore's opening. The electrode 170 may be ring-shaped, such as in a plan view of the film 150 illustrated in FIG. 6B.

The apparatuses according to the illustrated embodiments of FIGS. 4 and 5, may include a second voltage controlling unit 190, which independently controls a voltage applied to the electrode 170. Thus, when a single molecule of the target material passes completely through the pore 160, the second voltage controlling unit 190 applies a voltage to the electrode 170, and thus another single molecule of the target material may not pass through the pore 160. Accordingly, only a single molecule of the target material may be immobilized on the substrate, whenever the first voltage controlling unit 180 applies a voltage once.

As described above, according to the one or more of the above embodiments of the invention, a desired target material may be efficiently immobilized on a substrate.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A method of immobilizing a target material on a substrate, the method comprising:
applying a voltage across a first solution comprising the target material in contact with a surface of a film including a pore disposed therein, a second solution in contact with an opposite surface of the film, and a substrate disposed facing the opposite surface of the film;
moving the target material from the first solution and through the pore of the film; and
immobilizing the target material on the substrate.

2. The method of claim 1, wherein a polarity of the voltage applied to the first solution is opposite to a net charge of the target material, and
wherein a polarity of the voltage applied to the second solution is the same as the net charge of the target material.

3. The method of claim 1, wherein the film comprises a plurality of pores.

4. The method of claim 1, wherein the film comprises an array comprising a plurality of pores.

5. The method of claim 1, wherein a diameter of the narrowest cross section of the pore in a plan view of the film, is in a range of about 1 nanometer to about 1000 nanometers.

6. The method of claim 1, wherein the target material is at least one selected from the group consisting of deoxyribonucleic acid, ribonucleic acid, peptide nucleic acid, locked nucleic acid, protein, peptide, polysaccharides, a metal particle and any mixtures thereof.

7. The method of claim 1, wherein the target material comprises a reactant group which couples with the substrate.

8. The method of claim 1, wherein each of the first solution and the second solution comprises an electrolyte solution.

9. The method of claim 1, wherein the substrate is spaced apart from the opposite surface of the film by a distance in a range of about 1 nanometer to about 100 nanometers.

10. The method of claim 1, further comprising:
controlling passage of the target material through the pore by applying a voltage across the pore disposed in the surface of the film.

11. An apparatus for immobilizing a target material on a substrate, the apparatus comprising:
a first chamber comprising a film including a pore disposed therein, the film being a wall of the first chamber;
a second chamber comprising the film including the pore disposed therein, the film being a wall of the second chamber;
a first electrode electrically connected to the first chamber;
a second electrode electrically connected to the second chamber; and
a substrate disposed in the second chamber,
wherein the first electrode and the second electrode are arranged so that a voltage is applied across the film to the first chamber and the second chamber.

12. The apparatus of claim 11, wherein the film comprises a plurality of pores.

13. The apparatus of claim 11, wherein the film comprises an array comprising a plurality of pores.

14. The apparatus of claim 11, wherein a diameter of the narrowest cross section of the pore in a plan view of the film is in a range of about 1 nanometer to about 1000 nanometers.

15. The apparatus of claim 11, wherein the film including the pore disposed therein, is a portion of a wall of or is an entire wall shared by the first chamber and the second chamber.

16. The apparatus of claim 11, wherein the second chamber is detachable from the apparatus.

17. The apparatus of claim 11, wherein the substrate is disposed in the second chamber, or is positioned to face the film including the pore disposed therein as the wall of the second chamber.

18. The apparatus of claim 11, wherein the target material comprises a reactant group which couples with the substrate.

19. The apparatus of claim 11, further comprising a first voltage controlling unit which controls a voltage applied across the pore of the film.

20. The apparatus of claim 11, further comprising an electrode disposed adjacent to and around the pore of the film.

21. The apparatus of claim 19, wherein the film comprises a plurality of pores and an electrode is disposed adjacent to and around every pore.

22. The apparatus of claim 21, further comprising a second voltage controlling unit which controls a voltage applied to the electrode, independently from the first voltage controlling unit.

23. The apparatus of claim 11, further comprising a distance controlling unit which controls a distance between a surface of the substrate on which the target material is to be immobilized, and the film including the pore disposed therein which is disposed in the second chamber.

24. An apparatus for immobilizing a target material on a substrate, the apparatus comprising:
a first chamber comprising a film including a pore disposed therein, the film being a wall of the first chamber;
a second chamber module;
a second chamber module coupling unit which couples the second chamber module with the first chamber, such that the coupled second chamber module and the first chamber forms a second chamber comprising the film including the pore disposed therein, the film being a portion of a wall shared by the first chamber;
a first electrode which is electrically connected to the first chamber; and
a second electrode which is electrically connected to the second chamber,
wherein the first electrode and the second electrode are arranged so that a voltage is applied across the film to the first chamber and the second chamber.

25. The apparatus of claim 24, wherein the second chamber module is a vessel comprising the substrate disposed therein, and comprising an opened portion facing the film including the pore disposed therein, the film being a portion of a wall of the second chamber module.

26. The apparatus of claim 24, wherein the substrate is included in the second chamber module or is positioned to face the film with the pore disposed therein, the film being a portion of a wall of the second chamber module.

27. The apparatus of claim 26, wherein, when the substrate is included in the second chamber module, the substrate is included in a solution of the second chamber module or is fixed to a substrate fixation unit.

28. The apparatus of claim 26, further comprising a first voltage controlling unit which controls a voltage applied across the pore of the film.

29. The apparatus of claim 26, further comprising a distance controlling unit which controls a distance between a surface of the substrate on which the target material is to be immobilized, and the portion of the wall shared by the first chamber and the second chamber module which contains the film including the pore disposed therein.

30. The apparatus of claim 24, further comprising an electrode disposed adjacent to and around the pore of the film.

31. The apparatus of claim 24, wherein the film comprises a plurality of pores and the electrode is disposed adjacent to and around every pore.

32. The apparatus of claim 31, further comprising a second voltage controlling unit which controls a voltage applied to the electrode, independently from the first voltage controlling unit.
